(19) United States
(12) Patent Application Publication
(10) Pub. No.: US 2004/0161193 A1
(43) Pub. Date: Aug. 19, 2004

(54) Optical resonator, fabrication of concave mirror thereof, and optical filter using the same

(75) Inventor: Young-Joo Yee, Seongnam (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/750,925

(22) Filed: Dec. 30, 2003

(30) Foreign Application Priority Data
Feb. 12, 2003 (KR) 08880/2003

(51) Int. Cl. G02B 6/26

(52) U.S. Cl. 385/31; 385/15; 385/39

(57) ABSTRACT

An optical resonator comprises: a transparent lower substrate for light penetration; a plane mirror formed at one surface of the lower substrate; an upper substrate coupled to the lower substrate with a certain gap; a concave mirror formed at one surface of the upper substrate for forming a resonance cavity of a hemispherical shape with the plane mirror; and a micro actuating means for controlling a gap of the resonance cavity. Disclosed are the micro optical resonator capable of minimizing an insertion loss due to an alignment error of an optical fiber system and tuning a wavelength of a output optical signal so as to efficiently obtain an output optical signal having a predetermined narrow bandwidth from an input optical signal having a broad bandwidth, a fabrication method of a micro concave mirror thereof, and an optical filter using the same.

### BACKGROUND OF THE INVENTION

1. Field of the Invention

The present invention relates to an optical resonator, a fabrication method of a concave mirror thereof, and an optical filter using the same, and more particularly, to a optical resonator capable of minimizing an insertion loss due to an alignment error of an optical fiber system and tuning a wavelength of a output optical signal so as to efficiently obtain an output optical signal having a predetermined narrow bandwidth from an input optical signal having a broad bandwidth, a fabrication method of a concave mirror thereof, and an optical filter using the same.

2. Description of the Conventional Art

Recently information and communications technology are strikingly being developed through a high-speed optical system that can transmit and receive a huge quantity of data. Especially, according to a trend that multimedia information including various data such as moving images, a voice signal, a letter signal, and etc. which is transmitted with a high speed, and interactive communications and the number of users thereof are excessively being increased, the conventional communication networks using a copper transmission line is obliged to have limitations. Therefore, a communications network using an optical fiber system in which a huge quantity of data can be transmitted with a high speed is being considered as the alternative proposal. This optical fiber communication method is being changed into a DWDM (dense wavelength division multiplexing) which is a fiber-optics transmission technique that employs light wavelengths to transmit data parallel-by-bit or serial-by-character at one time. According to this, optical signal processing techniques for separating, amplifying, or attenuating a transmission optical signal with the multiplexed each wavelength or a signal with a specific wavelength is considered to be important. To this end, an optical resonator for separating a signal with a specific wavelength and an optical filter using the same become important devices.

Generally, the conventional optical resonator such as the Fabry-perot interferometer has a structure that two plane mirrors are disposed to face each other and a resonance cavity is formed therebetween. Under this structure, when an incident angle of input light is not aligned to be vertical for the plane mirrors and thus a little alignment error is generated, an intensity of output light is greatly decreased thus to increase an insertion loss.

In order to solve the problem as set forth in the above, the optical fiber system have to be limited very severely or an amplifier of an output optical signal has to be additionally provided in the optical fiber system, thereby increasing a production cost of the optical resonator and an optical filter using the same and having very complicated structures.

Also, in order to enhance the efficiency of optical output, said additional devices are required thus to have a difficulty in reducing the size of the optical resonator and the optical filter.

### SUMMARY OF THE INVENTION

Therefore, an object of the present invention is to provide an optical resonator capable of minimizing an insertion loss due to an alignment error of an optical fiber system and tuning a wavelength of a output optical signal so as to efficiently obtain an output optical signal having a predetermined narrow bandwidth from an input optical signal having a broad bandwidth, a fabrication method of a concave mirror thereof, and an optical filter using the same.

To achieve these and other advantages and in accordance with the purpose of the present invention, as embodied and broadly described herein, there is provided an optical resonator comprising: a transparent lower substrate for light penetration; a plane mirror formed at one surface of the lower substrate; an upper substrate coupled to the lower substrate with a certain gap; a concave mirror formed at the upper substrate for forming a resonance cavity of a hemispherical shape with the plane mirror; and a micro actuating means for controlling a gap of the resonance cavity.

To achieve these and other advantages and in accordance with the purpose of the present invention, as embodied and broadly described herein, there is also provided an optical filter comprising: a transparent lower substrate for light penetration; a plane mirror formed at one surface of the lower substrate; an upper substrate coupled to the lower substrate with a certain gap; a concave mirror formed at the upper substrate for forming a resonance cavity of a hemispherical shape with the plane mirror; a micro actuating means for controlling a gap of the resonance cavity; an input optical fiber disposed below the lower substrate for passing input light; an output optical fiber disposed at the periphery of the input optical fiber for passing output light; an optical fiber alignment/assembly unit for aligning the input optical fiber and the output optical fiber; and a lens disposed between the lower substrate and the optical fiber alignment/assembly unit for transmitting input light outputted from the input optical fiber to the resonance cavity and an output light emitted from the resonance cavity to the output optical fiber.

To achieve these and other advantages and in accordance with the purpose of the present invention, as embodied and broadly described herein, there is also provided a fabrication method of a concave mirror of an optical resonator comprising the steps of: forming an etch masking layer at both surfaces of a silicon substrate; patterning an etch window at one etch masking layer surface of the both surfaces; etching the silicon substrate through the etch window and thereby forming a cavity of a hemispherical shape; selectively removing the etch masking layer; forming a reflecting layer on a surface of the silicon substrate where the hemispherical cavity is formed; forming a thick photo resist layer on the reflecting layer and then planarizing; polishing the thick photo resist layer and the reflective layer so as for the thick photo resist layer to remain inside the hemispherical cavity; and selectively removing the thick photo resist layer remaining inside the hemispherical cavity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a disassembled perspective view showing a first embodiment of an optical resonator according to the present invention;

FIG. 2 is a frontal section view showing the first embodiment of the optical resonator according to the present invention;

FIG. 3 is a disassembled perspective view showing a second embodiment of the optical resonator according to the present invention;

FIG. 4 is a frontal section view showing the second embodiment of the optical resonator according to the present invention;

FIG. 5 is a plane view showing an inner construction of an upper substrate of the optical resonator according to the second embodiment of the present invention;

FIG. 6 is a plane view showing an inner construction of a lower substrate of the optical resonator according to the second embodiment of the present invention;

FIG. 7 is a construction view showing an optical filter according to the present invention; and

FIGS. 8A to 8H are cross-sectional views showing a fabrication process of a concave mirror of the optical resonator according to the present invention.

### DETAILED DESCRIPTION OF THE PREFERRED EMBODIMENTS

Reference will now be made in detail to the preferred embodiments of the present invention, examples of which are illustrated in the accompanying drawings.

Hereinafter, an optical resonator according to the present invention will be explained.

Even if a plurality of embodiments can exist in the optical resonator according to the present invention, the most preferable embodiment will be explained.

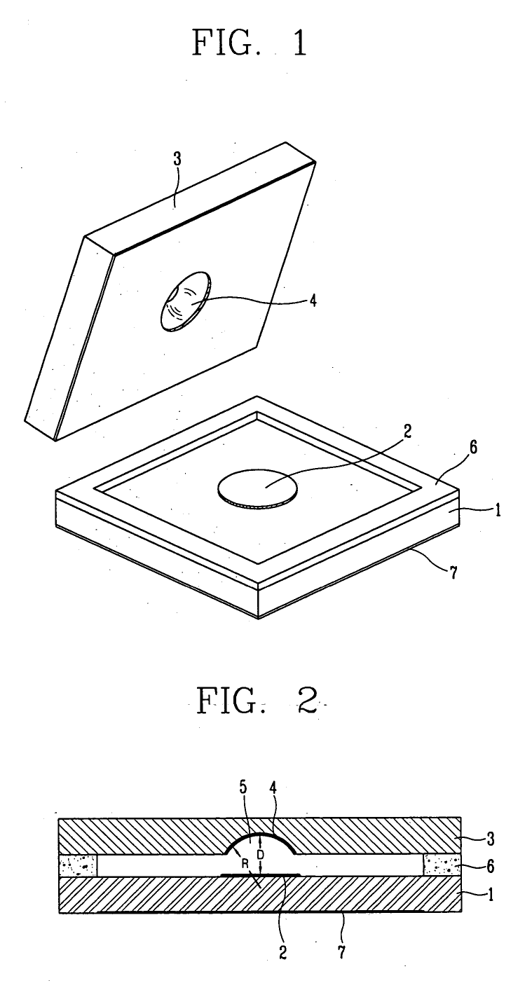

FIG. 1 is a disassembled perspective view showing a first embodiment of the optical resonator according to the present invention, and FIG. 2 is a frontal section view showing the first embodiment of the optical resonator according to the present invention.

As shown, the optical resonator according to the first embodiment of the present invention comprises: a lower substrate 1 having a certain area and a predetermined thickness and formed of a transparent material for light penetration; a plane mirror 2 formed at one surface of the lower substrate 1 for passing light which has been incident through the lower substrate 1; an upper substrate 3 having a certain area and a predetermined thickness and coupled to the lower substrate 1 with a certain gap; and a concave mirror 4 formed at one surface of the upper substrate 3 to face the plane mirror 2, for forming a resonance cavity 5 of a hemispherical shape with the plane mirror 2 and reflecting light which has been incident through the plane mirror 2.

A bonding portion 6 having a predetermined height and a width is formed at edges on one surface of the lower substrate 1 where the plane mirror 2 is formed, so that the edges on one surface of the upper substrate 3 is coupled to the bonding portion 6. According to this, the upper substrate 3 is apart from the lower substrate 1 with a certain gap. The bonding portion 6 can be also formed at edges on one surface of the upper substrate 3.

The concave mirror 4 is formed by alternately stacking hetero dielectric thin film layers having different refractive indexes several times in order to enhance a reflectivity, and the plane mirror 2 is formed by alternately stacking hetero dielectric thin film layers having different refractive indexes several times or is formed of metallic thin film layers in order to have a semitransparent characteristic.

Also, an anti-reflecting layer 7 for minimizing a insertion loss due to a reflection of input light is coated on one surface of the lower substrate 1 onto which light is made to be incident.

In the optical resonator according to the present invention, a input optical signal can be confined in the cavity 5 not to be sensitive to the alignment error of the optical fiber system, thereby reducing an insertion loss of the optical resonator generated from the alignment error of an optical fiber system.

Confining input light in the hemispherical cavity can be effectively performed under a condition that a curvature R of the concave mirror is larger than a distance D between the plane mirror and the concave mirror.

Hereinafter, the second embodiment of the optical resonator according to the present invention will be explained in more detail.

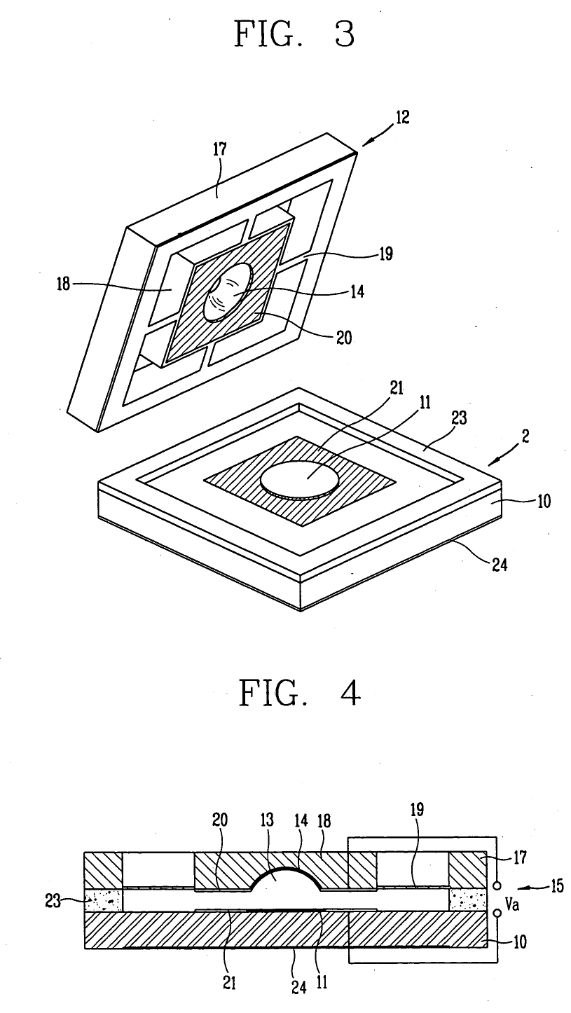

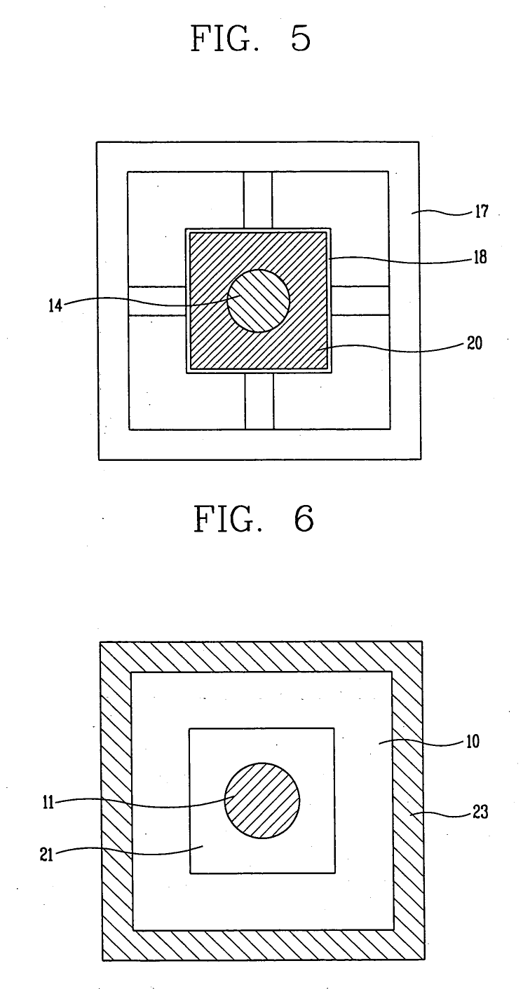

FIG. 3 is a disassembled perspective view showing the second embodiment of the optical resonator according to the present invention, FIG. 4 is a frontal section view showing the second embodiment of the optical resonator according to the present invention, FIG. 5 is a plane view showing an inner construction of an upper substrate of the optical resonator according to the second embodiment of the present invention, and FIG. 6 is a plane view showing an inner construction of a lower substrate of the optical resonator according to the second embodiment of the present invention.

As shown, the optical resonator according to the second embodiment of the present invention comprises: a lower substrate 10 having a certain area and a predetermined thickness and formed of a transparent material for light penetration; a plane mirror 11 formed at one surface of the lower substrate 10 for passing light which has been incident through the lower substrate 10; an upper substrate 12 having a certain area and a predetermined thickness and coupled to the lower substrate 10 with a certain gap; a concave mirror 14 formed at one surface of the upper substrate 12 to face the plane mirror, for forming a resonance cavity 13 of a hemispherical shape with the plane mirror 11 and reflecting light which has been incident through the plane mirror 11; and a micro actuating means 15 for controlling a gap of the resonance cavity 13 of a hemispherical shape.

The upper substrate 12 includes a fixed frame 17 coupled to edges on one surface of the lower substrate 10; a movable part 18 disposed in the fixed frame 17 and having the concave mirror 14 at one surface thereof; and a plurality of elastic supporting elements 19 for connecting the fixed frame 17 and the movable part 18 each other so that the movable part 18 can be elastically suspended at the fixed frame 17.

The micro actuating means 15 is composed of a parallel plate capacitor including a first electrode 20 formed at a predetermined region of a periphery of the concave mirror 14 formed at one surface of the movable part 18; a second electrode 21 formed at one surface of the lower substrate 10 to face the first electrode 20 with a certain gap; and a voltage source Vₐ electrically connected to the first and second electrodes 20 and 21 for generating an electrostatic force between the two electrodes 20 and 21.

The first and second electrodes 20 and 21 are preferably formed of a metallic thin film layer having a high conductivity.

Preferably, the plurality of elastic supporting elements 19 are symmetrically formed as a radial shape between the fixed frame 17 and the movable part 18 so that the concave mirror 14 can be moved in a vertical direction.

A bonding portion 23 having a certain height and width is formed at edges on one surface of the lower substrate 10 where the plane mirror 11 is formed, so that the fixed frame 17 is coupled to the bonding portion 23. According to this, the concave mirror 14 formed at the movable part 18 coupled to the plurality of elastic supporting elements 19 is apart from the plane mirror 11 formed at the lower substrate 10 with a certain gap.

The concave mirror 14 is formed by alternately stacking hetero dielectric thin film layers having different refractive indexes several times in order to enhance a reflectivity, and the plane mirror 11 is formed by alternately stacking hetero dielectric thin film layers having different refractive indexes several times or is formed of metallic thin film layers of in order to have a semitransparent characteristic.

Also, an anti-reflecting layer 24 for minimizing a insertion loss due to a reflection of input light is coated on one surface of the lower substrate 10 onto which light is made to be incident.

Operation of the optical resonator according to the second embodiment of the present invention will be explained as follows.

When a voltage is applied to the first and second electrodes 20 and 21, the movable part 18 is moved towards the lower substrate 10 by an electrostatic force due to an electric field induced between the two electrodes. Also, a position where a restoration force of the plurality of elastic supporting elements 19 which is increased in proportion to a displacement of the movable part 18 becomes equal to said electrostatic force is a position of the concave mirror 14 formed at the movable part 18.

That is, since the gap of the resonance cavity 13, that is, the distance between the concave mirror 14 and the plane mirror 11 is varied according to the position of the movable part 18, a wavelength of light resonated inside the resonance cavity 13 of a hemispherical shape is varied. Therefore, by arbitrarily controlling the position of the concave mirror 14 formed at the movable part 18, a wavelength of output optical signal can be controlled minimizing the insertion loss due to the alignment error of the optical fiber system

Hereinafter, an optical filter using the optical resonance according to the present invention will be explained.

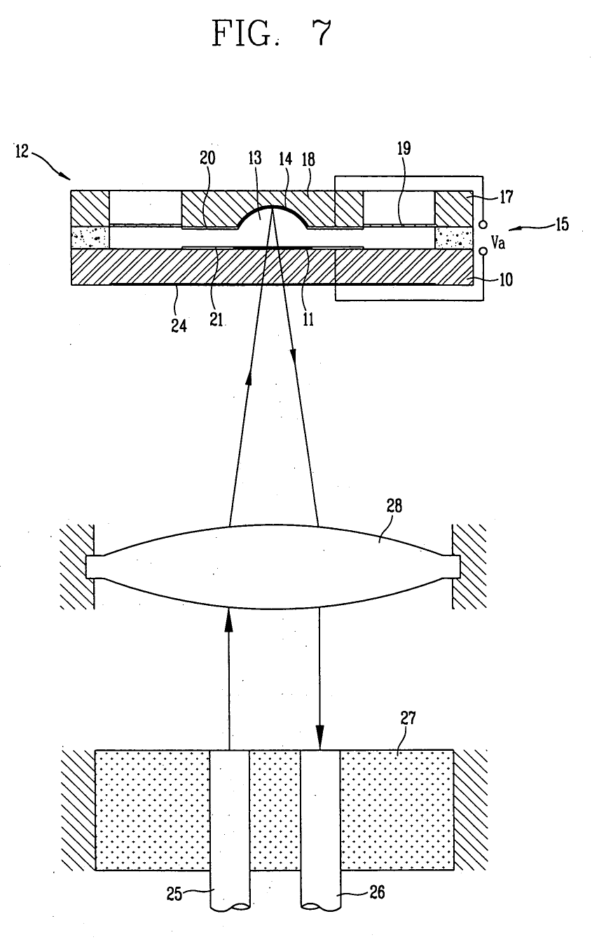

FIG. 7 is a construction view showing the optical filter according to the present invention.

The optical filter comprises a lower substrate 10 having a certain area and a predetermined thickness and formed of a transparent material for light penetration; a plane mirror 11 formed at one surface of the lower substrate 10 and for passing light which has been incident through the lower substrate 10; an upper substrate 12 having a certain area and a predetermined thickness and coupled to the lower substrate 11 with a certain gap; a concave mirror 14 formed at one surface of the upper substrate 12 to face the plane mirror 11, for forming a resonance cavity 13 of a hemispherical shape with the plane mirror 11 and reflecting light which has been incident through the plane mirror 11; a micro actuating means 15 for controlling a gap of the resonance cavity 13 of a hemispherical shape; an input optical fiber 25 disposed below the lower substrate 11 for passing input light; an output optical fiber 26 for passing light emitted from the resonance cavity 13; an optical fiber alignment/assembly unit 23 formed of ferrule and etc. for inserting the two optical fibers 25 and 26 and thus fixing to a predetermined position; and a lens 24 disposed between the lower substrate 10 and the optical fiber alignment/assembly unit 23 for transmitting input light to the resonance cavity 13 and output light emitted from the resonance cavity 13 to an output optical fiber 22.

Herein, the upper substrate 12 and the micro actuating means 15 have the same constructions as the optical resonator according to the second embodiment of the present invention.

Operation of the optical filter using the optical resonator according to the present invention will be explained as follows.

First, a input optical signal having a broad bandwidth incident through the input optical fiber 25 passes through a lens 28 thus to be refractive, and thereby is made to be incident on the resonance cavity 13 of a hemispherical shape formed between the concave mirror 14 and the plane mirror 11. At this time, by controlling the gap of the resonance cavity 13 by the micro actuating means 15, the resonated the input optical signal is converted into an output optical signal having a narrow bandwidth centering around an arbitrary frequency and outputted through the output optical fiber 26 via the lens 28 in a state of not being sensitive to the alignment error of the optical fiber system.

Especially, in the optical communication using a WDM(wavelength division multiplexing) method, the optical filter can be used as a tunable filter.

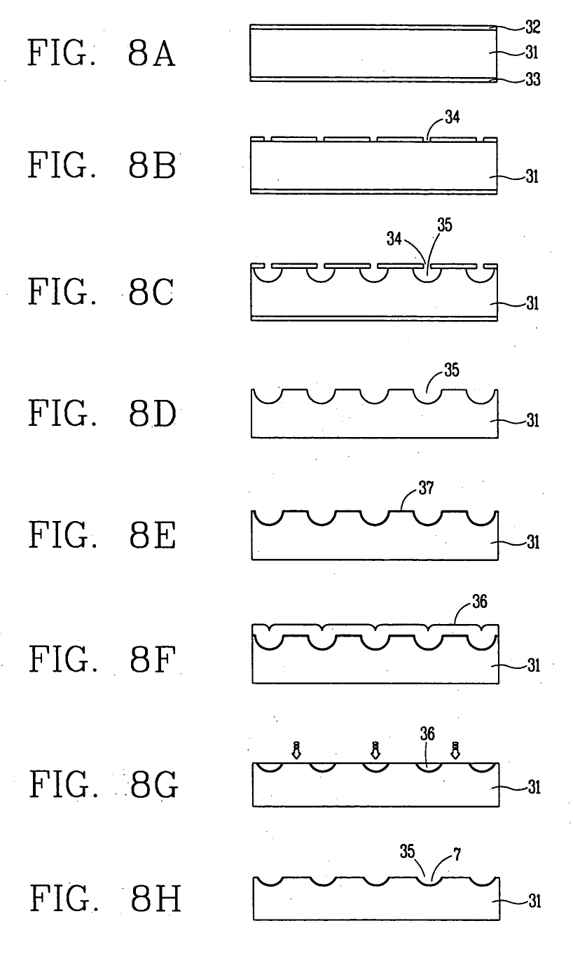

FIGS. 8A to 8H are cross-sectional views showing a fabrication process of a concave mirror of the optical resonator according to the present invention. Hereinafter, the fabrication method of the concave mirror of the optical resonator according to the present invention will be explained in more detail.

First, as shown in FIG. 8A, a silicon substrate 31 is used as a base material, and etch masking layers 32 and 33 are formed at upper and lower surfaces of the silicon substrate 31. The etch masking layers 32 and 33 are composed of material having a high etching selectivity for silicon and are formed by MEMS (micro electro mechanical system) fabrication technology. In case that the silicon etching method to be later performed is an isotropic wet etching, the etch masking layer composed of a metal such as gold is preferably used.

Next, as shown in FIG. 8B, a photo resist layer is coated on the etch masking layer 32 formed on the upper surface of the silicon substrate 31, then an etch window 34 to be silicon-etched therethrough is patterned, then the etch masking layer 32 of the upper portion exposed through the etch window 34 of the photo resist layer is selectively removed, and then the photo resist layer is removed thus to complete the etch window 34.

Subsequently, as shown in FIG. 8C, the silicon substrate 31 exposed through the etch window 34 is etched by an isotropic etching method. The isotropic etching method includes an etching for the patterned wafer with a predetermined depth by immersing into HNA solution which is mixed solution with hydrofluioric acid (HF), nitric acid (HNO₃), and acetic acid(CH₃COOH), an etching for the patterned wafer with a predetermined depth by exposing to gas such as XeF₂ or BrF₃, or an etching for the patterned wafer in SF₆ gas activated as a plasma state by a reactive ion etching method. Especially, according to the isotropic wet etching method using HNA solution has an etch stop characteristic at a predetermined depth so that a cavity 35 of a hemispherical shape can be easily obtained. Thus the isotropic wet etching method using the HNA solution is a preferable one for increasing the yield and the uniformity of a final product.

Next, as shown in FIG. 8D, the etch masking layers 32 and 33 remaining on the silicon substrate 31 where the cavity 35 is formed are selectively removed.

Then, as shown in FIG. 8E, dielectric thin film layers having different refractive indexes such as a silicon oxidation layer, a silicon nitride layer, a titanium oxide layer and etc. are alternately stacked on the surface of the silicon substrate 31 where the cavity 35 is formed, thereby forming a reflective layer 37 having a high reflectivity. A thickness and the number of times of stacking are preferably determined so as to maximize a reflectivity.

Next, as shown in FIG. 8F, a thick photo resist layer 36 is coated at the silicon surface having a plurality of the hemispherical cavity 35 where the reflective layer 37 is formed, and the thick photo resist layer 36 is thermally processed thus to be planarized.

Subsequently, as shown in FIG. 8G, the thick photo resist layer 36 and the reflective layer 37 formed on the upper surface of the silicon substrate 31 are polished by using a chemo-mechanical polishing technology and then removed so that the thick photo resist layer 36 can remain only inside the hemispherical cavity 35.

Next, as shown in FIG. 8H, the thick photo resist layer remaining inside the hemispherical cavity 35 is selectively removed, thereby forming concave mirror 4 or 14.

Additionally, the silicon substrate 31 having the concave mirror 14 fabricated by said method is provided with the fixed frame 17, the plurality of elastic supporting elements 19, and the electrodes 20 and 21 by using a MEMS (micro electro mechanical system) fabrication technology, thereby completing the upper substrate 12 of the optical resonator according to the second embodiment of the present invention.

The semitransparent plane mirror 2 or 11 can be formed on the upper surface of the lower substrate 1 or 10 by a conventional semitransparent mirror fabrication method, and a metal solder is deposited at the edges of the lower substrate 1 or 10 by a lift-off method or an electroplating technique thus to be patterned the bonding portion 6 or 23 having a predetermined width and height. Also, anti-reflecting coating layer 7 or 24 for minimizing reflection of incident light are deposited on the lower surface of the lower substrate 1 or 10.

The upper substrate 3 or 12 and the lower substrate 1 or 10 fabricated by said method are aligned, then bonded to each other, and cut thus to be individually separated, thereby fabricating the optical resonator of a high uniformity according to the present invention. Also, said method enables a mass production.

As aforementioned in detail, in the optical resonator according to the present invention, the plane mirror and the concave mirror are formed to face each other thereby to constitute the resonance cavity of a hemispherical shape. According to this, an insertion loss is minimized, output optical signal characteristics less sensitive to assembly/alignment errors of the optical fiber system can be obtained, and a wavelength of output optical signal can be tuned by controlling the gap of the resonance cavity.

Also, since a mass production is possible by using the MEMS fabrication technology, a productivity is enhanced and the uniformity and the accuracy of a final product are increased.

Besides, in the optical filter including the optical resonator according to the present invention, allowance ranges for assembly/alignment errors of the optical fiber system become wide, thereby facilitating an assembly, decreasing an inferiority rate at the time of the assembly, and reducing a production cost.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An optical resonator comprising:
a transparent lower substrate for light penetration;
a plane mirror formed at one surface of the lower substrate;
an upper substrate coupled to the lower substrate with a certain gap; and
a concave mirror formed at one surface of the upper substrate for forming a resonance cavity of a hemispherical shape with the plane mirror.

2. The optical resonator of claim 1, wherein a curvature of the concave mirror is larger than a gap of the resonance cavity of a hemispherical shape, that is, a distance between the concave mirror and the plane mirror.

3. The optical resonator of claim 1, wherein the concave mirror is formed by alternately stacking hetero dielectric thin film layers having different refractive indexes.

4. The optical resonator of claim 1, wherein the plane mirror is a semitransparent mirror formed by alternately stacking hetero dielectric thin film layers having different refractive indexes or formed of a metallic thin film layer.

5. The optical resonator of claim 1, wherein a anti-reflecting layer is coated on one surface of the lower substrate onto which incident light is made to be incident.

6. An optical resonator comprising:
a transparent lower substrate for light penetration;
a plane mirror formed at one surface of the lower substrate;
an upper substrate coupled to the lower substrate with a certain gap;
a concave mirror formed at one surface of the upper substrate for forming a resonance cavity of a hemispherical shape with the plane mirror; and
a micro actuating means for controlling a gap of the resonance cavity.

7. The optical resonator of claim 6, wherein the upper substrate comprises:
a fixed frame coupled to an edge of one surface of the lower substrate;
a movable part disposed in the fixed frame and having the concave mirror at one surface thereof; and
a plurality of elastic supporting elements for making the movable part be elastically suspended at the fixed frame.

8. The optical resonator of claim 7, wherein the micro actuating means comprises:
a first electrode formed at one surface of the movable part that the concave mirror is formed;
a second electrode formed at the lower substrate 10 to face the first electrode with a certain gap; and
a voltage source electrically connected to the first and second electrodes for generating an electrostatic force between the two electrodes.

9. The optical resonator of claim 6, wherein a position of the concave mirror is a position where a restoration force of the plurality of elastic supporting elements which is increased in proportion to a displacement of the movable part becomes equal to said electrostatic force.

10. The optical resonator of claim 6, wherein a curvature radius of the concave mirror is larger than a distance between the concave mirror and the plane mirror.

11. The optical resonator of claim 6, wherein the concave mirror is formed by alternately stacking hetero dielectric thin film layers having different refractive indexes.

12. The optical resonator of claim 6, wherein the plane mirror is a semitransparent mirror formed by alternately stacking hetero dielectric thin film layers having different refractive indexes or formed of a metal thin film layer.

13. The optical resonator of claim 6, wherein a anti-reflecting layer is coated on one surface of the lower substrate onto which incident light is made to be incident.

14. The optical resonator of claim 6, wherein the plurality of elastic supporting elements are symmetrically formed as a radial shape between the fixed frame and the movable part so that the concave mirror can be moved in a vertical direction.

15. An optical filter comprising:
a transparent lower substrate for light penetration;
a plane mirror formed at one surface of the lower substrate;
an upper substrate coupled to the lower substrate with a certain gap;
a concave mirror formed at the upper substrate for forming a resonance cavity of a hemispherical shape with the plane mirror;
a micro actuating means for controlling a gap of the resonance cavity;
an input optical fiber disposed below the lower substrate for passing input light;
an output optical fiber disposed at a periphery of the input optical fiber for passing output light;
an optical fiber alignment/assembly unit for aligning the input optical fiber and the output optical fiber; and
a lens disposed between the lower substrate and the optical fiber alignment/assembly unit for transmitting input light emitted from the input optical fiber to the resonance cavity and output light emitted from the resonance cavity to the output optical fiber.

16. A fabrication method of a concave mirror of an optical resonator comprising the steps of:
forming an etch masking layer at both surfaces of a silicon substrate;
patterning an etch window at one etch masking layer surface of the both surfaces;
etching the silicon substrate through the etch window and thereby forming a cavity of a hemisphere shape;
selectively removing the etch masking layer;
forming a reflecting layer on a surface of the silicon substrate where the hemispherical cavity is formed;
forming a thick photo resist layer on the reflecting layer and then planarizing;
polishing the thick photo resist layer and the reflective layer so as for the thick photo resist layer to remain inside the hemispherical cavity.
selectively removing the thick photo resist layer remaining inside the hemispherical cavity.

17. The method of claim 16, wherein the hemispherical cavity is formed by using an isotropic wet etching.

18. The method of claim 16, wherein the hemispherical cavity is formed by using a reactive ion etching method in SF₆ activated as a plasma state.

19. The method of claim 16, wherein the etch masking layer for forming the hemispherical cavity is a metal material such as gold.

20. The method of claim 16, wherein the reflecting layer is formed by alternately stacking hetero dielectric thin film layers having different refractive indexes such as a silicon oxidation layer, a silicon nitride layer, a titanium oxide layer and etc.
